(19) United States
(12) Patent Application Publication
(10) Pub. No.: US 2004/0241323 A1
(43) Pub. Date: Dec. 2, 2004

(54) Method for applying adhesive to a substrate

(75) Inventors: Caroline M. Ylitalo, Stillwater, MN (US); Peter T. Elliott, Woodbury, MN (US); John C. Clark, White Bear Lake, MN (US); Naiyong Jing, Woodbury, MN (US); Gary A. Korba, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/447,803

(22) Filed: May 29, 2003

(51) Int. Cl. B05D 1/36

(52) U.S. Cl. 427/258; 156/315; 156/314; 156/277; 156/307.3; 156/307.5; 156/291; 427/372.2; 427/398.1; 427/96.1

(57) ABSTRACT

Methods of applying adhesive to a surface of a substrate comprise: digitally applying a fixable fluid material to a portion of the substrate surface, fixing the first fluid material to form a fixed coating in contact with the substrate surface, wherein the fixed coating has at least one boundary that encloses a region of the substrate surface within the at least one boundary, and applying a second fluid material comprising at least one of an adhesive and an adhesive precursor to at least a portion of the enclosed region of the substrate surface. Various products, including laminated products, may be prepared according to such methods.

### FIELD

The present invention relates to methods for adhesive bonding.

### BACKGROUND

Precise placement of adhesives is important for a wide variety of adhesive bonding applications. In one method, an adhesive dam is printed (e.g., by screen printing) onto a substrate to define an area in which a liquid adhesive is later applied. Such a method has some versatility in that the liquid adhesive need only be applied within the area defined by the adhesive dam, thereby permitting the use of applicators (e.g., syringe pumps) that may not be capable of high resolution dispensing. Adhesive dams typically have a significant height (e.g., at least about 150 micrometers) that aids in containing the liquid adhesive within the boundaries of the dam. However, methods for applying adhesive dams may not be well suited to substrates that have raised or lowered topographical features (e.g., attached electrical components), and/or may not be well suited to short run applications (i.e., those applications wherein the location, position, and/or shape of the adhesive dam changes frequently).

It would be desirable to have additional methods for confining a liquid adhesive to a region of a substrate surface.

### SUMMARY

In one aspect, the present invention provides a method of applying adhesive to a surface of a substrate comprising:

digitally applying a fixable first fluid material to a portion of the surface of the substrate,

fixing the fixable first fluid material to form a fixed coating in contact with the surface of the substrate, wherein the fixed coating has at least one boundary that encloses a region of the surface of the substrate within the at least one boundary, wherein the fixed coating has an average receding contact angle with water that is at least 30 degrees higher than the average receding contact angle of the enclosed region of the surface of the substrate with water; and

applying a second fluid material comprising at least one of an adhesive and an adhesive precursor to at least a portion of the enclosed region of the surface of the substrate.

In another aspect, the present invention provides a method of applying adhesive to the surface of a substrate comprising:

digitally applying a fixable fluid material to a portion of the substrate surface,

fixing the first fluid material to form a fixed coating in contact with the substrate surface, wherein the fixed coating has at least one boundary that encloses a region of the substrate surface within the at least one boundary, and wherein the fixed coating comprises at least one of a silicone and a fluoropolymer;

applying second fluid material comprising at least one of an adhesive and an adhesive precursor to at least a portion of the enclosed region of the substrate surface.

In another aspect, the present invention provides an article comprising:

a substrate having a surface;

a first coating supported on the surface of the substrate comprising at least one fluoropolymer, wherein the coating has at least one boundary enclosing a region of the substrate surface within the at least one boundary; and

a second coating, in contact with the enclosed region, comprising at least one of an adhesive and an adhesive precursor.

According to some embodiments of the present invention, materials and/or adhesive precursors may be applied by an inkjet printing technique.

In this application, all contact angles with water refer to determinations using deionized water at 22° C., unless otherwise specified.

### BRIEF DESCRIPTION OF DRAWINGS

FIG. 1 is a process flow diagram according to one embodiment of the present invention; and

FIG. 2 is a process flow diagram according to one embodiment of the present invention;

FIG. 3 is a printing pattern used in Examples 1, 2, and 3;

FIG. 4 is a digital photograph of an exemplary adhesive coated film prepared according to the present invention; and

FIG. 5 is a digital photograph of an exemplary adhesive coated film prepared according to the present invention.

### DETAILED DESCRIPTION

According to the present invention, a first fluid material is digitally applied to a portion of a surface of a substrate and fixed to create a fixed coating (e.g., a thin coating) on a portion of the substrate surface that has sufficiently low surface energy, as compared to the surface energy of the adjacent substrate surface, to prevent a fluid material comprising an adhesive or an adhesive precursor from receding from the uncoated substrate surface onto the low energy coating. Thus, the fixed coating forms a type of “adhesive dam”, although in contrast to conventional adhesive dams, no particular topography (e.g., thickness) need be achieved to be useful in the present invention. The first fluid material is applied and fixed in such a manner that it encloses an uncoated area of the substrate surface. By using digital techniques, it may be possible to apply the first fluid material to a substrate surface more precisely and with higher resolution, than by conventional application techniques (e.g., screen printing). Additionally, using digital techniques it is typically possible to apply the first fluid material to substrate surfaces in unique patterns without wasted time and material associated with changing equipment between patterns, as is common practice using non-digital methods such as screen or flexographic printing.

After fixing the first fluid material, a second fluid material comprising at least one of an adhesive and an adhesive precursor is applied to at least a portion of the substrate surface enclosed by the fixed coating. The second fluid material typically spreads over at least a portion of the enclosed area of the substrate surface until it encounters a boundary with the fixed coating where the difference in surface energies between the enclosed region of the substrate surface and the fixed coating, in combination with surface tension of the second fluid material, serve to inhibit spreading of the second fluid material past the boundary.

The first fluid material is fixable to the surface of the substrate. Fixing may be, for example, spontaneous (e.g., as in the case of some thixotropic materials) or result from an additional step. Exemplary methods of fixing include evaporation (e.g., removal of volatile solvent), cooling (e.g., resulting in a phase change from liquid to solid, or viscosity thickening), and curing (e.g., polymerization and/or crosslinking). After fixing the first fluid material forms a fixed coating. The fixed coating has at least one boundary that encloses a region of the substrate surface within the at least one boundary.

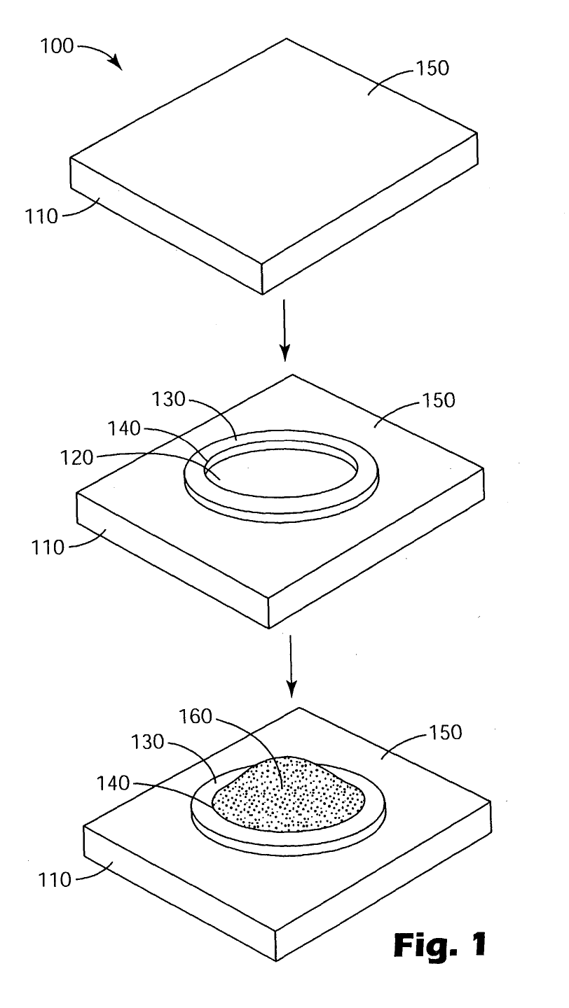

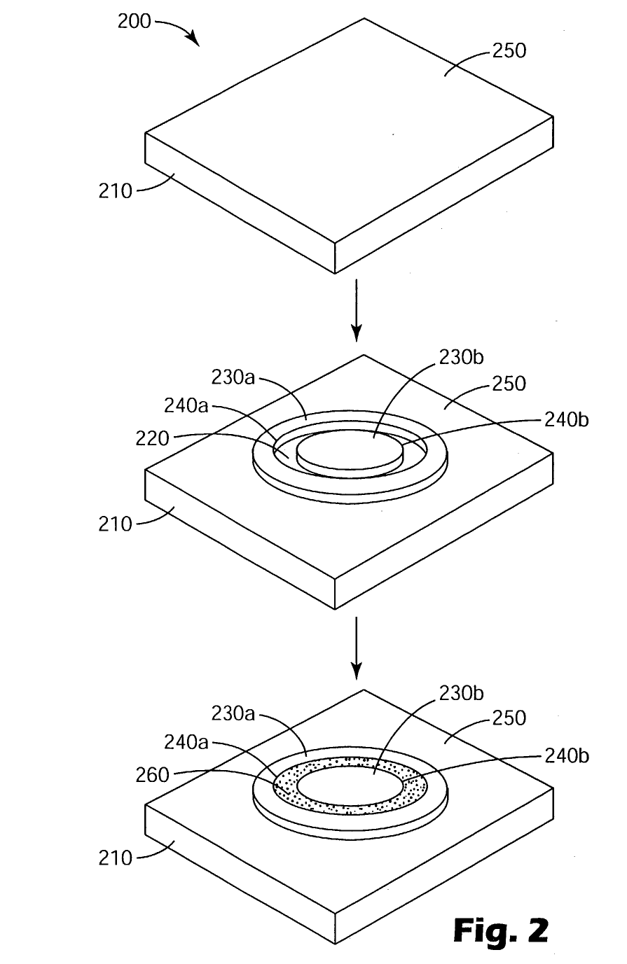

Exemplary processes according to the present invention are shown in FIGS. 1 and 2.

Referring now to FIG. 1, in exemplary process 100, substrate 110 has surface 150. Fixable fluid material (not shown) is digitally applied to substrate surface 150 and fixed to the substrate to form fixed coating 130 such that the inner boundary 140 of fixed coating 130 encloses area 120 of substrate surface 150. Second fluid material 160 comprising at least one of an adhesive and an adhesive precursor is then applied to the enclosed area 120 of substrate surface 150.

Another exemplary process 200 is shown in FIG. 2, wherein substrate 210 has surface 250. Fixable fluid material (not shown) is digitally applied to substrate surface 250 and fixed to form fixed coatings 230a,b on substrate surface 250. Inner boundary 240a of fixed coating 230a and outer boundary 240b of fixed coating 230b collectively enclose area 220 of substrate surface 250. Second fluid material 260, comprising at least one of an adhesive and an adhesive precursor, is then applied to enclosed area 220 of substrate surface 250.

The boundary or boundaries enclosing a region of the substrate surface are effectively continuous, although they may be discontinuous if the spacing between adjacent discontinuous portions is sufficiently close as to prevent spontaneous wetting of the second fluid material to a portion of the substrate surface outside the enclosed region.

The fixable fluid material comprises at least one component that after fixing results in a fixed coating having a lower average surface energy than the substrate surface. This may be accomplished, for example, by including one or more components that exhibit low surface energy (e.g., silicones, silicone precursors, fluoropolymers, fluoropolymer precursors, various self-assembling materials, and combinations thereof), and optionally one or more reactive components (e.g., one or more polymerizable monomers) to form a reaction product having a lower surface energy than the substrate surface.

For example, the fixed coating may have an average receding contact angle with water that is at least 20 degrees higher (e.g., at least 30, at least 40, or even at least 50 degrees higher) than the average receding contact angle of the enclosed region of the substrate surface with water. In some embodiments according to the present invention, fixed coatings may have a receding contact angle with water of greater than about 80 degrees, 90 degrees, 100 degrees, or even greater than about 110 degrees.

Contact angles may be readily measured according to a variety of methods that are well known in the art, including for example, ASTM D5725-99 “Standard Test Method for Surface Wettability and Absorbency of Sheeted Materials Using an Automated Contact Angle Tester” (1999). In instances, wherein the surface area of the material to be evaluated is too small for analysis, or wherein the surface has topographical features that may influence the results obtained, results based on a larger smooth film of the same composition should be used.

Silicones, silicone precursors, fluoropolymers, fluoropolymer precursors, fluorinated self-assembling materials, and combinations thereof may be present at any concentration in the fixable fluid material. However, to facilitate the rate of deposition of such materials on the substrate surface their concentration in the fixable fluid material may be greater than 5, 10, 20, 30, 40, or even greater than 50 percent by weight, based on the total weight of the material. Silicones, silicone precursors, fluoropolymers, fluoropolymer precursors, fluorinated self-assembling materials (i.e., SAMs), and combinations thereof may comprise greater than about 20, 30, 40, 50, 60, 70, 80, or even greater than 90 percent by weight of the fixable fluid material, optionally excluding any solvent (e.g., volatile organic solvent) that may be present.

The fixable fluid material may be prepared by combining constituent components according to one or more well known techniques such as, for example, stirring, heating, sonicating, milling, and combinations thereof.

In one embodiment, the fixable fluid material may comprise at least one of a fluoropolymer and a fluoropolymer precursor. As used herein, the term “fluoropolymer” refers to any organic fluorinated polymer (e.g., a polymer having a fluorine content of at least 20 percent by weight based on the total weight of the polymer). The fluoropolymer may, for example, be dispersed or dissolved in solvent, or be a liquid at the selected digital application temperature. Fluoropolymer precursors typically comprises oligomeric and or monomeric fluorinated organic compounds that have condensable, polymerizable, and/or crosslinkable groups, and may optionally contain one or more curatives (e.g., initiator, hardener, catalysts).

Fluoropolymer solutions useful for preparing fluoropolymer-coated substrates may be any solution comprising soluble at least one fluoropolymer and/or fluoropolymer precursor. Useful fluoropolymer and fluoropolymer precursor solutions are described, for example, in U.S. Pat. No. 4,132,681 (Field et al.); U.S. Pat. No. 4,446,269 (Silva et al.); U.S. Pat. No. 6,350,306 (Tunelli et al.); U.S. Pat. No. 5,459,191 (Tuminello et al.); U.S. Pat. No. 6,365,276 (Rudisi et al.); and in commonly assigned U.S. application Ser. No. XXXX bearing Attorney Case Number 58436US002 and entitled “METHOD OF MODIFYING A SURFACE OF A SUBSTRATE AND ARTICLES THEREFROM” (Jing et al.), filed concurrently herewith; the disclosures of which are incorporated herein by reference.

Useful solutions of commercially available fluoropolymers and fluoropolymer precursors include, for example, thermoset FEVE fluoropolymer solutions marketed by Asahi Glass Company (Tokyo, Japan) under the trade designations “LUMIFLON LF200”, “LUMIFLON LF600X”, and “LUMIFLON LF910LM”; fluoropolymer solutions marketed by 3M Company under the trade designations “3M NOVEC ELECTRONIC COATING EGC-1700”, “3M NOVEC ELECTRONIC COATING EGC-1702”, and “3M NOVEC ELECTRONIC COATING EGC-1704”; and fluoropolymer solutions marketed by Central Glass Company (Tokyo, Japan) under the trade designations “CEFRAL COAT A202B”, “CEFRAL COAT A600X”, and “CEFRAL COAT PX-40”.

Exemplary useful commercially available solvent soluble fluoropolymers include a copolymer of VDF and HFP (VDF/HFP monomer weight ratio of 90/10) available from Dyneon, LLC (Oakdale, Minn.) under the trade designation “KYNAR 2800”; a copolymer of VDF and TFE (VDF/TFE monomer weight ratio of 39/61) available from Dyneon, LLC (Oakdale, Minn.) under the trade designation “KYNAR 7201”; and terpolymers of VDF, HFP, and TFE monomers (VDF/HFP/TFE) having the trade designations “THV 200” (monomer weight ratio 40/20/40), “L-5447” (monomer weight ratio 65/11/24), “KYNAR 9301” (monomer weight ratio 56/19/25), “DYNEON FLUOROELASTOMER FE-5530” (monomer weight ratio 63/28/9), “DYNEON FLUOROELASTOMER FT-2481” (monomer weight ratio 44/33/23), “DYNEON FLUOROELASTOMER FE-5730” (monomer weight ratio 41/35/24), and “DYNEON FLUOROELASTOMER FE-5830” (monomer weight ratio 36.6/38.5/24.9); and fluoropolymers marketed by E. I. du Pont de Nemours & Company under the trade designations “TEFLON AF 1600” and “TEFLON AF 2400”.

The choice of solvent to dissolve the fluoropolymer typically depends on the specific fluoropolymer. Methods for selecting appropriate solvents are well known in the art. Exemplary organic solvents that may be used for dissolving the fluoropolymer include amides (e.g., N,N-dimethylformamide), ketones (e.g., methyl ethyl ketone), alcohols (e.g., methanol), ethers (e.g., tetrahydrofuran), hydrofluoroethers (e.g., those available from 3M Company under the trade designations “3M NOVEC ENGINEERED FLUID HFE 7100”, “3M NOVEC ENGINEERED FLUID HFE-7200”), perfluorinated solvents (e.g., a perfluorinated organic solvent available from 3M Company under the trade designation “3M FLUORINERT ELECTRONIC LIQUID FC-77”), and combinations thereof.

Useful dispersible fluoropolymers include, for example, those described in U.S. Pat. No. 6,518,352 (Visca et al.), U.S. Pat. No. 6,451,717 (Fitzgerald et al.), and U.S. Pat. No. 5,919,878 (Brothers et al.), PCT patent publication WO 02/20676 A1 (Krupers et al., published Mar. 14, 2002), the disclosures of which are incorporated herein by reference.

Useful dispersions of commercially available fluoropolymers and fluoropolymer precursors include, for example, polyvinylidene difluoride (PVDF) dispersions (e.g., as that marketed by Atofina Chemical (Philadelphia, Pa.) under the trade designation “KYNAR 500”); polytetrafluoroethylene (PTFE) dispersions (e.g., as marketed by E.I. du Pont de Nemours & Company under the trade designations “TEFLON PTFE GRADE 30”, “TEFLON PTFE GRADE 307A”; or as marketed by Dyneon under the trade designations “DYNEON TF 5032 PTFE” or “DYNEON TF 5050 PTFE”); tetrafluoroethylene—hexafluoropropylene—vinylidene fluoride dispersions (e.g., as marketed by Dyneon under the trade designation “DYNEON THV 220D FLUOROTHERMOPLASTIC” and “DYNEON THV 340D FLUOROTHERMOPLASTIC”).

In another embodiment, the fixable fluid material may comprise at least one silicone and/or silicone precursor (e.g., monomers, oligomers, and polymers having one or more reactive silyl groups such as —SiR¹₃₋ₙ(OR²)ₙ, wherein R¹ represents an aryl or alkyl group, each R² independently represents H, an alkyl group (e.g., having from 1 to 6 carbon atoms), or an acyl group, and n is 1, 2, or 3) that may be cured to form silicones as described in, for example, U.S. Pat. No. 6,461,419 (Wu et al.), the disclosure of which is incorporated herein by reference.

Exemplary silicones and silicone precursors include hydroxy and/or alkoxy terminated polydimethylsiloxanes having a molecular weight of 400 to 150,000; hydroxy and/or alkoxy terminated diphenylsiloxane-dimethylsiloxane copolymers; hydroxy and/or alkoxy terminated polydiphenylsiloxanes; hydroxysilyl and/or alkoxysilyl terminated polytrifluoropropylmethylsiloxanes, polyesters, polyurethanes, and polyacrylates; dialkyl- and substituted dialkyl dialkoxysilanes (e.g., diethyldiethoxysilane, dimethyldimethoxysilane, diethyldiethoxysilane, diisobutyldimethoxysilane, dimethyldiethoxysilane, diisopropyldimethoxysilane, bis(3-cyanopropyl)dimethoxysilane, (2-chloroethyl)methyldimethoxysilane, chloromethylmethyldiethoxysilane, (2-chloroethyl)methyldiisopropoxysilane, (3-chloropropyl) methyldimethoxysilane,(3-cyanopropyl)methyldimethoxysilane, cyclohexylethyldimethoxysilane, dodecylmethyldiethoxysilane, isobutylmethyldimethoxysilane, 3-mercaptopropylmethyldimethoxysilane, mercaptomethylmethyldiethoxysilane, methacryloxypropylmethyldiethoxysilane, methacryloxypropylmethyldimethoxysilane, methyldiethoxysilane, methyldimethoxysilane, n-octadecylmethyldiethoxysilane; n-octylmethyldiethoxysilane, dicyclopentyldimethoxysilane); aryl and diaryl substituted alkoxysilanes (e.g., diphenyldimethoxysilane, phenyldiethoxysilane, phenylmethyldiethoxysilane, and phenylmethyldimethoxysilane); hydroxysilyl and alkoxysilyl substituted arenes (e.g., 1,4-bis(hydroxydimethylsilyl)benzene and 1,3-bis(methoxydimethylsilyl)benzene); trialkylsilyl substituted alkoxysilanes (e.g., bis(trimethylsilylmethyl)dimethoxysilane and trimethylsilylmethyldimethoxysilane); cyclic alkoxysilanes (e.g., 1,1-diethoxy-1-silacyclopent-3-ene); acyloxy substituted silanes (e.g., dimethyldiacetoxysilane, vinylmethyldiacetoxysilane, and diethylbenzoyloxyacetoxysilane); geminal silanediols (e.g., diphenylsilanediol, and dicyclohexylsilanediol); alkyl and/or aryl substituted cyclic siloxanes (e.g., 3-(3,3,3-trifluoropropyl) heptamethyltrisiloxane, hexamethyltrisiloxane, and octamethyltetrasiloxane); alkenyl substituted alkoxysilanes (e.g., vinylethyldiethoxysilane, vinylmethyldimethoxysilane, and vinylphenyldiethoxysilane); and combinations thereof.

In one embodiment, silicone precursors may contain at least one compound having at least 3 (e.g., from 4 to 6) reactive silyl groups per molecule. The reactive silyl groups can be, for example, alkoxy silyl or acyloxy silyl groups. Examples of such compounds include trifunctional crosslinkers (e.g., isobutyltrimethoxysilane, methytriethoxysilane, methytrimethoxysilane, octyltriethoxysilane, propyltrimethoxysilane, phenyltrimethoxysilane, chloropropyltriethoxysilane, chloropropyltriethoxysilane, mercaptopropyltrimethoxysilane, glycidyloxypropyltrimethoxysilane, methacryloxypropyltrimethoxysilane, vinyltriethoxysilane, and vinyltrimethoxysilane); tetrafunctional crosslinkers (e.g., tetramethoxysilane, tetraethoxysilane, 1,3-dimethyltetramethoxydisiloxane, 1,3-di-n-octyltetramethoxydisiloxane, 1,3-divinyltetraethoxydisiloxane, 1,1,3,3-tetraethoxy-1,3-dimethyldisiloxane, tetrakis(butoxyethoxyethoxy)silane, tetrakis(ethoxyethoxy)silane, tetrakis(trimethylsiloxy)silane, tetrakis(2-ethylhexoxy)silane, tetrakis(2-methacryloxyethoxysilane), tetrakis(methoxyethoxyethoxy)silane, tetrakis(methoxyethoxy)silane, tetrakis(methoxypropoxy)silane, tetra-n-propoxysilane); and higher functionality crosslinkers (e.g., bis[3-(methyldimethoxysilyl)propyl]-polypropylene oxide, bis(triethoxysilyl)ethane, bis(triethoxysilyl)ethylene, bio(triethoxysilyl)methane, 1,9-bis(triethoxysilyl)nonane, bis(triethoxysilyl)-1,7-octadiene, bis(triethoxysilyl)octane, bis[3-(triethoxysilyl)propyl]-tetrasulfide, bis(3-(triethoxysilyl)propyl)urea, bis(trimethoxysilyl)ethane, 1,4-bis(trimethoxysilylethyl)benzene, bis(trimethoxysilyl)hexane, bis(trimethylsiloxy)cyclobutene, di-t-butoxydiacetoxysilane, hexamethoxydisilane, hexaethoxydisilane, tetraacetoxysilane, tetraallyloxysilane, tetra-n-butoxysilane, 1-triethoxysilyl)-2-(diethoxymethylsilyl)ethane; and functional polymers (e.g., poly(diethoxysiloxane), diethoxysiloxane-s-butylaluminate copolymers, diethoxysiloxane-ethyltitanate copolymers, diethoxysiloxane-ethyl phosphate copolymers); and combinations thereof.

Additional silicone-based fixable compositions are described in, for example, U.S. Pat. No. 5,217,805 (Kessel et al.) and U.S. Pat. No. 5,286,815 (Leir et al.), the disclosures of which are incorporated herein by reference.

The first fluid material may optionally contain at least one curing agent (e.g., catalyst, initiator, crosslinker, hardener, or the like) in an amount effective to at least partially cure the first fluid material. Such curing agents are typically selected based on the specific chemical nature of the first fluid composition using methods well known in the art.

Acid generating catalysts are one useful class of curing agent. Such catalysts provide acid (for example, after an activation step) that typically facilitates curing (i.e., crosslinking) of cationically polymerizable components (e.g., silicone precursors having hydrolyzable groups) that may be present in the first fluid material. Activation may be accomplished by heating or irradiating the first fluid composition with, for example, ultraviolet, visible light, electron beam or microwave radiation. Moisture required for the initial hydrolysis reaction of the curing mechanism may be obtained from, for example, the substrate, the composition itself, or, most commonly, atmospheric humidity. If used, catalyst is typically present in an amount of 0.1 to 20 parts by weight, for example, from 2 to 7 parts by weight, based on 100 parts by weight reactive silane functional compounds. Further details concerning useful acid catalysts may be found, for example, in U.S. Pat. No. 5,554,664 (Lamanna et al.); U.S. Pat. No. 5,514,728 (Lamanna et al.); and U.S. Pat. No. 5,340,898 (Cavezzan et al.), the disclosures of which are incorporated herein by reference.

In one embodiment, the first fluid material may comprise at least one self-assembling material. Such self-assembling materials are typically relatively small (e.g., having less than or equal to 30 carbon atoms, or even less than or equal to 18 carbon atoms) molecules, and are generally characterized by a relatively non-polar tail attached to a polar head group that can coordinate with a substrate surface. Useful self-assembling materials include those that can be fixed (e.g., tightly bound as a monolayer) to the surface of the substrate (e.g., by covalent or non-covalent bonding) as described, for example, in U.S. Pat. No. 6,433,359 (Kelley et al.) and U.S. Pat. No. 6,376,065 (Korba et al.), the disclosures of which is incorporated herein by reference. Such materials may be especially useful for metallic substrates such as for example, copper, nickel, silver, and gold.

Exemplary useful self-assembling materials include those having the formula

R_{f}-Z-X

wherein

R_{f} is a perfluoroalkyl group having from 1 to 22 carbon atoms;

Z is a divalent connecting group or a covalent bond; and

X is selected from the group consisting of —PO₃H, —CO₂H,

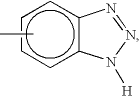

and salts thereof.

Useful perfluoroalkyl groups R_{f} include linear perfluoroalkyl groups (e.g., perfluoromethyl, perfluoropropyl, perfluorohexyl, perfluorooctyl, perfluorodecyl, perfluorohexadecyl, and perfluoroeicosyl) and branched perfluoroalkyl groups (e.g., perfluoroisopropyl, perfluoroisooctyl, and perfluoro(1,1,2-trimethylpentyl)).

Useful divalent connecting groups include, for example, a covalent bond; an organic group such as linear or branched divalent alkylene having from 1 to 22 carbon atoms (e.g., methylene, ethylene, propylene, decylene) or divalent arylene having from 6 to 10 carbon atoms; divalent aromatic hydrocarbons (e.g., phenylene); sulfur; oxygen; alkylimino (e.g., —NR—, wherein R is a lower alkyl group); carbonyl; carbonyloxy; carbonylamino; carbonyldioxy; sulfonyl; sulfonyloxy; sulfonamido; carbonamido; sulfonamidoalkylene (e.g., —SO₂NR₁(CH₂)ₓ—, wherein x is 1 to 6 and R₁ is lower alkyl having 1 to 4 carbon atoms); carbonamidoalkylene; carbonyloxy; ureylene; and combinations thereof. Other divalent connecting groups may also be used. In some embodiments, Z may be selected to be free of active hydrogen atoms (e.g., hydroxyl or acidic hydrogen atoms) or other hydrophilic groups, as these may tend to reduce the advancing contact angle with water of coatings prepared from such materials. In some embodiments, Z may be relatively small (e.g., having less than 20 atoms in the backbone connecting R_{f} and X).

Useful X groups include —PO₃H, −CO₂H,

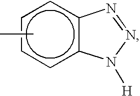

and salts thereof.

Exemplary useful salts include alkali metal salts (e.g. sodium, lithium, and potassium salts), ammonium salts and derivatives thereof (e.g., ammonium, alkylammonium, and quaternary ammonium salts), and quaternary phosphonium salts (e.g., tetramethylphosphonium and phenyltributyl phosphonium salts)

In some cases, it may be desirable to select R_{f} and Z such that, taken together, R_{f} and Z comprise at least 7 carbon atoms.

Further details concerning self-assembling materials and methods for their preparation may be found, for example, in commonly assigned U.S. application Ser. No. XXXX bearing Attorney Case Number 58567US002 and entitled “METHOD OF MODIFYING A SURFACE OF A SUBSTRATE AND ARTICLES THEREFROM” (Jing et al.), filed concurrently herewith; the disclosure of which is incorporated herein by reference.

In another embodiment, the fixable fluid material may comprise a combination of the foregoing fluoropolymers, silicones, and/or precursors thereof, and/or self-assembling materials.

The fixed coating may be solid or liquid, crosslinked or uncrosslinked, provided that it maintains a substantially constant position on the surface of the substrate while the second fluid material is applied to the enclosed region of the substrate surface.

The first fluid material may contain solvent (e.g., volatile solvent). Solvent may be present in amount sufficient to adjust the viscosity of the first fluid material, for example, to a viscosity suitable for a chosen digital application method. For example, if ink-jet printing is chosen as the digital application method, the first fluid material may be adjusted by addition of solvent to a viscosity of less than about 30 millipascal-seconds at 60° C. Exemplary solvents include water, organic solvents (e.g., mono-, di- or tri-ethylene glycols or higher ethylene glycols, propylene glycol, 1,4-butanediol or ethers of such glycols, thiodiglycol, glycerol and ethers and esters thereof, polyglycerol, mono-, di- and tri-ethanolamine, propanolamine, N,N-dimethylformamide, dimethylsulfoxide, dimethylacetamide, N-methylpyrrolidone, 1,3-dimethylimidazolidone, methanol, ethanol, isopropanol, n-propanol, diacetone alcohol, acetone, methyl ethyl ketone, propylene carbonate), and combinations thereof.

The first fluid material may contain one or more optional additives such as, for example, colorants, thixotropes, or thickeners.

The second fluid material comprises at least one of an adhesive and an adhesive precursor.

Exemplary adhesives include hot melt adhesives (e.g., ethylene-vinyl acetate copolymers, atactic polypropylene, low density polyethylene, low molecular weight polyethylene, polyester, polyamide, and styrene-butadiene block copolymer based hot melt adhesives), glues, and pressure sensitive adhesives (e.g., as described in U.S. Pat. No. 2,392,269 (Brinker et al.) and U.S. Pat. Publication No. 2002/0128340 (Young et al.), the disclosures of which are incorporated herein by reference).

Useful adhesive precursors include curable (i.e., thermosettable) monomers and resins such as, for example, epoxies, cyanates, isocyanates, urethane precursors, acrylates, polyimides, and combinations thereof.

Useful epoxies include those described for example in that contain cyclohexene oxide groups such as the epoxycyclohexanecarboxylates (e.g., 3,4-epoxycyclohexylmethyl 3,4-epoxycyclohexane carboxylate; 3,4-epoxy-2-methylcyclohexylmethyl 3,4-epoxy-2-methycyclohexanecarboxylate, and bis(3,4-epoxy-6-methylcyclohexylmethyl) adipate), diglycidyl ethers of bisphenol A, diglycidyl ethers of bisphenol F, epoxidized polybutadienes, epoxysilanes (e.g., beta-3,4-epoxycyclohexylethyltrimethoxy silane and gamma-glycidoxypropyltrimethoxy silane), 1,4-butanediol diglycidyl ether, hydrogenated bisphenol A-epichlorohydrin based epoxy resins, polyglycidyl ethers of phenol-formaldehyde novolak resins, and combinations thereof.

Useful cyanates include, for example, cyanate monomers (e.g., 1,3- and 1,4-dicyanatobenzene, 1,3,5-tricyanatobenzene, 2,2′- and 4,4′-dicyanatobiphenyl), bis(4-cyanatophenyl)methane, bis(3-chloro-4-cyanatophenyl)methane, bis(4-cyanatophenyl) ether, bis(p-cyanophenoxyphenoxy)benzene, di(4-cyanatophenyl)ketone, bis(4-cyanatophenyl)thioether, bis(4-cyanatophenyl)sulfone, tris(4-cyanatophenyl)phosphite, and tris(4-cyanatophenyl)phosphate); cyanate esters derived from phenolic resins (e.g., cyanate ester of novolac resins); and combinations thereof.

Useful polyisocyanates include, for example, include aromatic, aliphatic, and cycloaliphatic polyisocyanates such as 4,4′-diphenylmethane diisocyanate, toluene diisocyanate, xylylene diisocyanate, tetramethylxylene diisocyanate, naphthalene diisocyanate, para-phenylene diisocyanate, tetramethylene diisocyanate, hexamethylene diisocyanate, isophorone diisocyanate, oligomers and polymers thereof, and combinations of the foregoing. Further details concerning useful polyisocyanates and urethane precursors can be found, for example, in U.S. Pat. No. 4,950,696 (Palazzotto et al.), the disclosure of which is incorporated herein by reference.

Useful acrylates include, for example, monofunctional and multifunctional acrylate and methacrylate (i.e., (meth)acrylate) monomers (e.g., triethylene glycol diacrylate, pentaerythritol triacrylate, trimethylolpropane triacrylate, pentaerythritol trimethacrylate, glycerol triacrylate, trimethylolpropane trimethacrylate, trimethylolpropane triacrylate, 1,6-hexanediol diacrylate, 1,4-butanediol diacrylate, tetramethylene glycol diacrylate, tripropylene glycol diacrylate, ethylene glycol diacrylate, ethylene glycol dimethacrylate, polyethylene glycol diacrylate, pentaerythritol tetraacrylate, pentaerythritol tetramethacrylate, and 1,6-hexane diacrylate), acrylated urethanes (e.g., diacrylate esters of hydroxy terminated isocyanate extended polyesters or polyethers), acrylated epoxies (e.g., diacrylate esters of bisphenol A epoxy resins), acrylated polyesters (e.g., reaction products of acrylic acid with a dibasic acid/aliphatic/diol-based polyester), acrylated acrylics (e.g., acrylic oligomers or polymers that have reactive pendant or terminal acrylic acid groups capable of forming free radicals for subsequent reaction), and combinations thereof.

Adhesive precursors used in practice of the present invention may include, for example, filler, colorant, curative (e.g., one or more of a catalyst, crosslinker, and/or initiator), and combinations thereof.

After application of the second fluid material to the enclosed area of the substrate surface, it may be desirable to at least partially cure the adhesive precursor. For example, the adhesive precursor may be b-staged or cured sufficiently to form a pressure sensitive adhesive that may, for example, be subsequently bonded to a second substrate. It may also be useful to contact the adhesive precursor with a second substrate (e.g., an electrical component) prior to at least partially curing the adhesive precursor. Such methods may result in strong bonds between the original substrate and the second substrate.

The second fluid material may be applied to the enclosed region of the substrate surface by any known application method, including digital methods (e.g., as described herein) and non-digital application methods. Exemplary methods include application of the second fluid material using a syringe applicator, spray, heated nozzle, or the like. Although, the second fluid material may be applied to a portion of the enclosed region, it may be desirable in some embodiments to apply a sufficient amount of the second fluid material such that substantially the entire enclosed region is coated with the second fluid material.

Typically, any solid substrate may be used in practice of the present invention. For example, useful substrates may be opaque, translucent, clear, textured, patterned, rough, smooth, rigid, flexible, treated, primed, or a combination thereof. The substrate typically comprises organic and/or inorganic material. The substrate may be, for example, thermoplastic, thermoset, or a combination thereof. Exemplary substrates include films, plates, tapes, rolls, molds, sheets, blocks, molded articles, fabrics, and fiber composites (e.g., circuit boards), and may comprise at least one organic polymer such as polyimide, polyester, acrylic, polyurethane, polyether, polyolefin (e.g., polyethylene or polypropylene), polyamide, and combinations thereof. Exemplary inorganic substrates include metals (e.g., chromium, aluminum, copper, nickel, silver, gold, and alloys thereof), ceramics, glass, china, quartz, polysilicon, and combinations thereof.

The substrate may be treated, for example, to promote adhesion and/or wetting of the fixed first material and/or the fixed second material to the substrate. Exemplary treatments include corona treatment, flame treatment, primers, coupling agents, and combinations thereof. Exemplary primers include primers that form a hydrophilic or hydrophobic polymeric coating on the substrate surface. Exemplary coupling agents (e.g., titanate coupling agents, zirconate coupling agents, and silane coupling agents that are capable of affording titanium, zirconium, or silicon oxides upon pyrolysis). Exemplary silane coupling agents include vinyltriethoxysilane, gamma-mercaptopropyltrimethoxysilane, allyltriethoxysilane, diallyldichlorosilane, gamma-aminopropyltrimethoxysilane, triethoxysilane, trimethoxysilane, triethoxysilanol, 3-(2-aminoethylamino)propyltrimethoxysilane, tetraethyl orthosilicate, and combinations thereof. If used, coupling agents can be applied neat or from a solution thereof in, for example, a volatile organic solvent. Further details on chemical surface treatment techniques are described in, for example, S. Wu “Polymer interface and Adhesion” (1982), Marcel Dekker, New York, pages 406-434.

The fixable fluid material and, optionally, the second fluid material is/are digitally applied to the surface of the substrate. Typically, fluid materials are applied to the substrate surface as a thin coating (e.g., less than about 1 micrometer thickness), although thicker coatings may also be used. Fluid materials may be applied to the substrate surface as a continuous or discontinuous coating. Exemplary digital application methods include drop on demand methods such as spray jet, valve jet, and inkjet printing methods. Such methods are well known and are described, for example, in U.S. Pat. No. 6,513,897 (Tokie), the disclosure of which is incorporated herein by reference.

Inkjet printing methods are typically well-suited for applications wherein high resolution is desired. Exemplary inkjet printing methods include thermal inkjet printing, continuous inkjet printing, and piezoelectric (i.e., piezo) inkjet printing. Thermal ink-jet printers and/or print heads are readily commercially available from printer manufacturers such as Hewlett-Packard Corporation (Palo Alto, Calif.), and Lexmark International (Lexington, Ky.). Continuous inkjet print heads are commercially available from continuous printer manufacturers such as Domino Printing Sciences (Cambridge, United Kingdom). Piezo inkjet print heads are commercially available from, for example, Trident International (Brookfield, Conn.), Epson (Torrance, Calif.), Hitachi Data Systems Corporation (Santa Clara, Calif.), Xaar PLC (Cambridge, United Kingdom), Spectra (Lebanon, N.H.), and Idanit Technologies, Limited (Rishon Le Zion, Israel). Piezo inkjet printing is one useful method that typically has the flexibility to accommodate various fluids with a wide range of physical and chemical properties.

Techniques and formulation guidelines for inkjet printing are well known (see, for example, “Kirk-Othmer Encyclopedia of Chemical Technology”, Fourth Edition (1996), volume 20, John Wiley and Sons, New York, pages 112-117, the disclosure of which is incorporated herein by reference) and are within the capability of one of ordinary skill in the art. For example, inkjet printable compositions are commonly formulated to have a viscosity of less than about 35 millipascal-seconds at the jetting temperature.

Fluid materials used in practice of the present invention may be Newtonian or non-Newtonian (i.e., fluids that exhibit substantial shear thinning behavior). For ink-jet printing, fluid materials may be formulated to exhibit little or no shear thinning at the jetting temperature.

Fluid materials used in practice of the present invention may be digitally applied (e.g., inkjet printed) to any portion of the substrate surface by various techniques including, for example, moving the substrate relative to a fixed print head, or by moving print head relative to the substrate. Accordingly, methods of the current invention are generally capable of forming detailed patterns of fluid materials on the surface of a substrate. Fluid materials are typically digitally applied in a predetermined pattern (although random patterns may be used) as a coating onto a surface of the substrate as an array of dots, which depending on the wetting ability and the number of printing passes may coalesce, remain separated, or a combination thereof. For example, using ink-jet printing the array may have a resolution in at least one dimension of greater than or equal to 300 dots per inch (i.e., dpi) (120 dots/cm), 600 dpi (240 dots/cm), 900 dpi (350 dots/cm), or even greater than or equal to 1200 dpi (470 dots/cm), especially if using ink-jet printing techniques. Exemplary patterns include lines (e.g., straight, curved, or bent lines) that may form a geometric outline such as, for example, a polygon or an ellipse.

Fluid materials may be prepared by combining constituent components according to one or more well known techniques such as, for example, stirring, heating, sonicating, milling, and combinations thereof.

Methods according to the present invention are useful, for example, for preparing various articles including flexible circuits (i.e., flex circuits) as described in, for example, U.S. Pat. No. 5,433,632 (Chemey et al.), the disclosure of which is incorporated herein by reference), including bonded articles in which a second substrate is bonded to the substrate via adhesive.

Objects and advantages of this invention are further illustrated by the following non-limiting examples, but the particular materials and amounts thereof recited in these examples, as well as other conditions and details, should not be construed to unduly limit this invention.

### EXAMPLES

Unless otherwise noted, all reagents used in the examples were obtained, or are available, from general chemical suppliers such as Aldrich Chemical Company (Milwaukee, Wis.) or may be synthesized by known methods.

In the following examples “g” refers to grams, “mL” refers to milliliters. In the following examples, contact angles were measured using deionized water and a contact angle measurement apparatus obtained under the trade designation “VCA 2500XE VIDEO CONTACT ANGLE MEASURING SYSTEM” from AST Products (Billerica, Mass.).

Preparation of Fluoropolymer Dispersion A:

A 250 mL 3-necked flask was fitted with a condenser, a stirring rod, and a thermometer. A nitrogen fitting was also attached to the glassware with a mineral oil bubbler at the outlet of the condenser. The flask was charged with 25 g of N-methylperfluorooctylsulfonamidoethyl acrylate (preparable according to the general procedure described in U.S. Pat. No. 2,803,615 (Ahlbrecht et al.)), 32 g of acetone, 128 g of water, 0.2 gram of a water-soluble free radical initiator obtained under the trade designation “V-50” from Wako Chemicals USA, Inc. (Richmond, Va.), and 1.7 g of surfactant obtained under the trade designation “ETHOQUAD 18/12” from Akzo Nobel Chemicals, Inc. (Chicago, Ill.). The mixture was stirred under nitrogen for 20 minutes, with heating at 65° C. using a heating mantle and a thermal controller. The reaction was allowed to proceed for 8 hours while watching and controlling the exotherm. The reaction product was cooled, drained, filtered, and stripped of acetone by evaporation at reduced pressure. The resulting dispersion (Fluoropolymer Dispersion A) was cooled to room temperature. The dispersion had particle size of less than 100 nanometers as measured by dynamic light scattering. The solids content of the dispersion was 15 percent by weight and the surface tension was 28 dynes/centimeter (0.28 millinewtons/cm).

General Procedure for Preparation of Sulfopolyester Diol Precursor (PCPSSIP)

A mixture of 337.3 g of dimethyl 5-sodiosulfoisophthalate, 483 g of diethylene glycol, and 0.82 g zinc acetate was heated at 180° C., and the methanol by-product was distilled from the reaction mixture. After 4.5 hours ¹H NMR analysis of the reaction product showed that less than 1 percent residual methyl ester was present in the product. Dibutyltin dilaurate (1.51 g) was added to the reaction mixture, the temperature held at 180° C., and 1753 g epsilon-caprolactone (obtained from Union Carbide Corporation (Danbury, Conn.), since acquired by Dow Chemical (Midland, Mich.)) was added portion-wise over about a 30-minute period. When addition was complete, the reaction mixture was held at 180° C. for 4 hours, then cooled to afford the product, a polycaprolactone sodium sulfoisophthalate (PCPSSIP).

Preparation of SUS Dispersion A

An aqueous dispersion of a silanol-terminated sulfopoly(ester-urethane) was prepared by combining in a 1-liter 3-neck round bottom flask: 64.8 g of PCPSSIP (prepared according to the General Procedure for Preparation of Sulfopolyester Diol Precursor, and having a hydroxyl equivalent weight=370 g/equivalent), 10.86 g of polycaprolactone diol (obtained under the trade designation “TONE 201” from Union Carbide Corporation, hydroxyl equivalent weight of 262 g/equivalent), 14.30 g of ethylene glycol, 80.36 g of isophorone diisocyanate, 0.13 g of dibutytin dilaurate, and 90 mL of methyl ethyl ketone. The mixture was stirred with heating at 80° C. for 4 hours, after which time a solution of 5.34 g of 3-aminopropyltriethoxysilane and 5.34 g of butyl amine in 83 mL methyl ethyl ketone was added to the flask and the mixture stirred at 55° C. for an additional 15 minutes. As the mixture was vigorously stirred, 260 mL of water was added to the flask over a 15-minute period. The flask was then fitted with a distillation head and a condenser and the methyl ethyl ketone was distilled out of the flask under reduced pressure to afford a dispersion of a silanol-terminated sulfopoly(ester-urethane) in water. (SUS Dispersion A, 41 percent solids).

Preparation of SUS Dispersion B

An aqueous dispersion of a silanol-terminated sulfopoly(ester-urethane) was prepared by combining in a 1-liter 3-neck round bottom flask: 857.5 g of PCPSSIP (prepared according to the General Procedure for Preparation of Sulfopolyester Diol Precursor, and having a hydroxyl equivalent weight of 333 g/equivalent), 655 g of polycaprolactone diol (obtained under the trade designation “TONE 201” from Union Carbide Corporation), 749.4 g of 4,4′-methylenebis(cyclohexyl isocyanate), 1.1 mL of dibutytin dilaurate, and 2261.8 g of acetone. The mixture was stirred for 38 hours at 45° C., then a solution of 141.1 g of 3-aminopropyltriethoxysilane in 141 g of acetone was added to the flask and the mixture stirred at 45° C. for an additional 15 minutes.

As the mixture was vigorously stirred, 3566 g of water was added to the flask over a 30-minute period. The flask was then fitted with a distillation head and a condenser and the methyl ethyl ketone was distilled out of the flask under reduced pressure to afford a dispersion of a silanol-terminated sulfopoly(ester-urethane) in water (SUS Dispersion B, 43 percent by weight solids)

### Example 1

A solution was prepared containing 4 percent by weight of a fluoropolymer (a terpolymer of tetrafluoroethylene, hexafluoropropylene and vinylidene fluoride obtained under the trade designation “DYNEON THV 220 FLUOROTHERMOPLASTIC” obtained from Dyneon, LLC) in methyl ethyl ketone. The solution exhibited Newtonian behavior and had a viscosity of 4.1 millipascal-seconds.

A borosilicate glass plate (6 inches×12 inches) (15 cm×31 cm) was washed sequentially with methanol and then deionized water, and then dried by blowing nitrogen gas on the plate. The washed plate was then treated by immersing it for 1 minute into a solution of 1 percent by weight 3-aminopropyltriethoxysilane in methanol. The treated plate was removed from the solution and dried in air prior to printing.

The solution was inkjet printed onto the treated plate using a piezo inkjet print head obtained under the trade designation “XJ128-200” from Xaar, PLC (Cambridge, United Kingdom). The print head was mounted in fixed position, and the glass plate was mounted on an x-y translatable stage, which was moved relative to the print head while maintaining a constant distance between the print head and the stage. Accordingly, the fluoropolymer solution was printed at a resolution of 317×295 dots per inch (125×116 dots per cm) with a nominal drop volume of 70 picoliters.

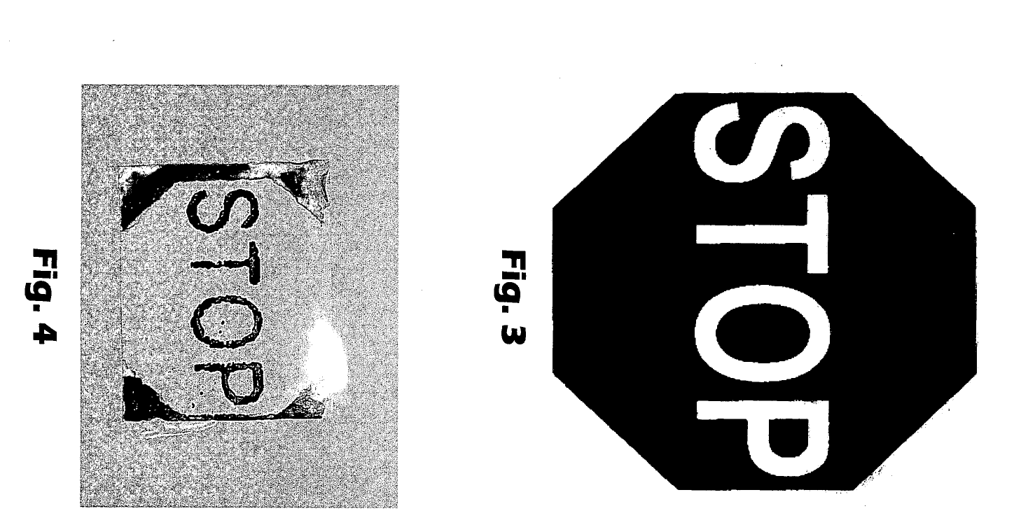

The resulting pattern was an octagon (4.5 inch height×4.5 inch width) having the letters “STOP,” (0.25 inch (0.63 cm) line width) unprinted in its interior, as shown in FIG. 3. The solution was deposited outside the letters and the letters themselves remained uncoated. The printed glass plate was allowed to air dry, resulting in a coated film of fluoropolymer surrounding the letters “STOP”.

Portions of the glass plate surface that were coated with the fluoropolymer film exhibited a receding contact angle with deionized water of 80 degrees and a static contact angle with deionized water of 102 degrees (measured using deionized water and a contact angle measurement apparatus obtained under the trade designation “VCA 2500XE VIDEO CONTACT ANGLE MEASURING SYSTEM” from AST Products (Billerica, Mass.). By contrast, unprinted sections of the glass (the “STOP” letters) exhibited a static contact angle with deionized water of 38 degrees (as measured by the same method).

An epoxy solution consisting of a 2 percent by weight solution of a cationic photocatalyst (obtained under the trade designation “CYRACURE UVI 6976” from Dow Chemical Company (Midland, Mich.)) in a cycloaliphatic epoxy resin (obtained under the trade designation “CYCLOALIPHATIC EPOXIDE RESIN ERL-4221” from DOW Chemical Company) was smeared with a spatula onto the “STOP” letters. The coated glass plate was then placed for 5 minutes in a 50° C. oven to reduce the viscosity of the epoxy and promote flow. When removed from the oven, it was seen that the epoxy solution had mostly receded from the fluoropolymer-coated letters and stayed confined in the uncovered glass regions, however, possibly due to the high viscosity of the epoxy solution, parts of it remained on top of the fluoropolymer coating in some regions. A piece of polyethylene terephthalate polyester film having a thickness of 38 micrometers was placed gently onto the letters covered with epoxy. The construction was cured by exposure to ultraviolet radiation using a UV processor equipped with an H-type bulb obtained from Fusion Systems Corporation (Rockville, Md.) under the trade designation “Fusion Systems UV Processor”. Irradiation was carried out through the glass at 100 percent power, 30 feet per minute (9.1 meters/minute), for 5 passes, followed by allowing the laminate to stand overnight at room temperature.

Attempts to peel the polyester film from the glass plate demonstrated that in regions where the cured epoxy resin was in contact with the polyester film and the fluoropolymer coating could be easily separated by hand (at the epoxy/fluoropolymer interface), while in regions where the cured epoxy resin was in contact with the polyester film and the glass plate, the polyester film and the glass plate could not be separated without damage to the polyester film.

### Example 2

A first fluid composition (Composition A) was prepared by combining with mixing 12 g of SUS Dispersion A, 12 g of SUS Dispersion B, 12.66 g diethylene glycol, 13.34 g deionized water, and 0.205 g of a silicone surfactant (obtained under the trade designation “SILWET L-77” from Crompton OSi Specialties (Middlebury, Conn.)) Composition A was coated onto vinyl sheet (50 micrometers thickness, obtained under the trade designation “CONTROLTAC PLUS GRAPHIC FILM 180-10” from 3M Company) using a Number 6 wire wound rod obtained from R D Specialties (Webster, N.Y.) and dried by heating in an oven at 70° C. for 5 minutes. The resulting dried coating had static/advancing/receding contact angles with deionized water of 73/80/26 degrees, respectively.

A second fluid composition (Composition B) was prepared by combining with mixing 15 g of Fluoropolymer Dispersion A, 7 g of diethylene glycol, and 0.205 g of a silicone surfactant (obtained under the trade designation “SILWET L-77” from Crompton Osi Specialties).

Composition B was coated onto vinyl sheet (50 micrometers thickness, obtained under the trade designation “CONTROLTAC PLUS GRAPHIC FILM 180-10” from 3M Company) using a Number 6 wire wound rod obtained from R D Specialties and dried by heating in an oven at 135° C. for 5 minutes. The resulting dried coating had static/advancing/receding contact angles with deionized water of 118/124/109 degrees, respectively.

Composition A was printed onto a vinyl sheet (obtained under the trade designation “CONTROLTAC PLUS GRAPHIC FILM, 180-10” from 3M Company) at room temperature using a piezo inkjet print head (obtained under the trade designation “XAARJET XJ-128” from Xaar, PLC (Cambridge, United Kingdom)). The print head was mounted in fixed position, and the vinyl sheet was mounted on an x-y translatable stage, which was moved relative to the print head while maintaining a constant distance between the print head and the stage. Accordingly, the materials were printed (35V driving voltage; 1.25 kHz pulse frequency) at room temperature at a resolution of 317×295 dots per inch (125×116 dots per cm) and a nominal drop volume of 30 picoliters.

Composition A was printed, then overprinted, in registration, once to ensure solid fill, in an 8 inch×10 inch (20 cm×25 cm) solid fill rectangular pattern. After printing Composition A, the printed vinyl film was dried in a convection oven at 70° C. This procedure provided a hydrophilic surface on the vinyl sheet.

Composition B was then printed and then over-printed two additional times, in registration, in an octagonal “STOP” sign pattern as in Example 1 onto the vinyl sheet. The printed vinyl sheet was dried in a convection oven at 130° C.

A pressure sensitive adhesive emulsion was prepared by combining 10.9 g of a 55 percent solids, water-based pressure sensitive adhesive emulsion obtained under the trade designation “ROBOND PS2000” from Rohm and Haas Company (Philadelphia, Pa.), 19.1 g deionized water, and 0.1 g Acid Fuchsin, sodium salt (70% dye content; Aldrich Chemical Company). The adhesive emulsion was coated onto the printed film prepared above using a wire wound rod (a No. 6 wire-wound rod obtained from R D Specialties (Webster, N.Y.)). The adhesive emulsion quickly receded (i.e., dewetted) from the portion of the vinyl film that was printed with Composition B and resided in the area with exposed Composition A as shown in FIG. 4.

### Example 3

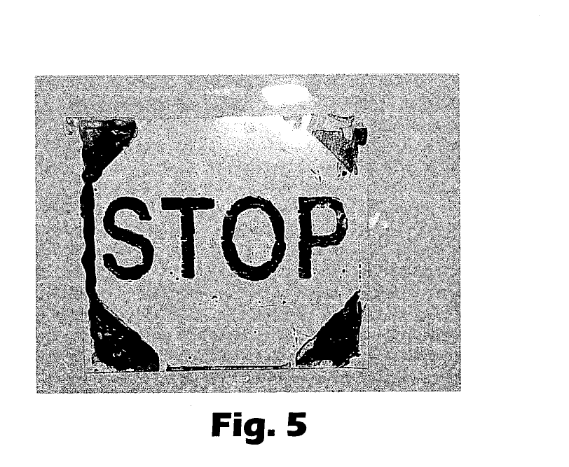

Example 2 was repeated except that Composition B was replaced by a composition (Composition C) which was prepared by combining with mixing 5 g of a silicone polymer obtained under the trade designation “3M SILICONE PLUS POLYMER”, cat. no. 42-0020-2940-5 from 3M Company, and 20 g of 2-butoxyethyl acetate. The adhesive emulsion quickly receded (i.e., dewetted) from the portion of the vinyl film that was printed with Composition C and resided in the area with exposed Composition A as shown in FIG. 5.

Various unforeseeable modifications and alterations of this invention may be made by those skilled in the art without departing from the scope and spirit of this invention, and it should be understood that this invention is not to be unduly limited to the illustrative embodiments set forth herein.

What is claimed is:

1. A method of applying adhesive to a surface of a substrate comprising:
digitally applying a fixable first fluid material to a portion of the surface of the substrate,
fixing the fixable first fluid material to form a fixed coating in contact with the surface of the substrate, wherein the fixed coating has at least one boundary that encloses a region of the surface of the substrate within the at least one boundary, wherein the fixed coating has an average receding contact angle with water that is at least 30 degrees higher than the average receding contact angle of the enclosed region of the surface of the substrate with water; and
applying a second fluid material comprising at least one of an adhesive and an adhesive precursor to at least a portion of the enclosed region of the surface of the substrate.

2. A method according to claim 1, wherein the second fluid material is adjacent to at least a portion of the fixed coating.

3. A method according to claim 1, wherein the fixed coating comprises a continuous coating.

4. A method according to claim 1, wherein the fixed coating comprises a discontinuous coating.

5. A method according to claim 1, wherein the fixed coating has at least two boundaries that taken together enclose a region of the substrate surface within the boundaries.

6. A method according to claim 1, wherein the fixed coating has a receding contact angle with water of greater than about 80 degrees.

7. A method according to claim 1, wherein the fixed coating has a receding contact angle with water of greater than about 110 degrees.

8. A method according to claim 1, wherein at least one of the fixable first fluid material and the second fluid material has a viscosity of less than 30 millipascal-seconds at 60° C.

9. A method according to claim 1, wherein at least one of the fixable first fluid material and the second fluid material is applied by inkjet printing.

10. A method according to claim 1, wherein at least one of the fixable first fluid material and the second fluid material is applied by piezo inkjet printing.

11. A method according to claim 1, wherein fixing comprises evaporating.

12. A method according to claim 1, wherein fixing comprises cooling.

13. A method according to claim 1, wherein fixing comprises at least one of polymerizing and crosslinking.

14. A method according to claim 1, wherein the substrate comprises organic polymer.

15. A method according to claim 14, wherein the polymer is selected from the group consisting of polyimide, polyester, polyurethane, polyether, polyolefin, polyamide, and a combination thereof.

16. A method according to claim 1, wherein the substrate comprises at least one of a film, a tape, and a sheet.

17. A method according to claim 1, wherein the substrate comprises a fiber composite.

18. A method according to claim 1, wherein the substrate comprises at least one of a circuit board and a flex circuit.

19. A method according to claim 1, wherein the first fluid material comprises a fluoropolymer dispersion, a fluoropolymer solution, a silicone polymer, or a combination thereof.

20. A method according to claim 1, wherein the first fluid material comprises a fluoropolymer dispersion, a fluoropolymer solution, or a combination thereof.

21. A method according to claim 1, wherein the fixable first fluid material comprises at least one compound having the formula
R_{f}-Z-X
wherein
R_{f} is a perfluoroalkyl group having from 1 to 22 carbon atoms;
Z is a divalent connecting group or a covalent bond; and
X is selected from the group consisting of —PO₃H, —CO₂H, 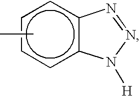
and salts thereof.

22. A method according to claim 21, wherein Z is selected from the group consisting of divalent alkylene having from 1 to 22 carbon atoms, divalent arylene having from 6 to 10 carbon atoms, oxygen, sulfur, carbonyl, carbonyloxy, carbonylamino, carbonyldioxy, sulfonyl, sulfonyloxy, alkylimino, sulfonamido, ureylene, and a combination thereof.

23. A method according to claim 1, wherein the adhesive precursor comprises epoxy resin, cyanate resin, acrylate resin, or a combination thereof.

24. A method according to claim 1, further comprising at least partially curing the adhesive precursor to form at least partially cured adhesive precursor.

25. A method according to claim 24, wherein at least partially cured adhesive precursor comprises a pressure sensitive adhesive.

26. A method according to claim 24, further comprising adhesively bonding a second substrate to the pressure sensitive adhesive.

27. A method according to claim 1, wherein the second fluid material comprises an adhesive precursor, further comprising contacting a second substrate with the second fluid material, and at least partially curing the adhesive precursor such that the second substrate becomes bonded to the first substrate.

28. A method according to claim 27, wherein the second substrate comprises at least one electrical component.

29. A method according to claim 1, wherein the second fluid material further comprises solvent, further comprising evaporating at least a portion of the solvent.

30. A method according to claim 29, wherein after evaporating at least a portion of the volatile solvent, the second fluid material comprises a pressure sensitive adhesive.

31. A method according to claim 1, wherein the first fluid material is applied as an array of dots, and wherein the array has a resolution in at least one dimension of greater than or equal to 300 dots per inch.

32. A method according to claim 1, wherein the adhesive precursor contacts substantially the entire enclosed region of the substrate surface.

33. A method of applying adhesive to the surface of a substrate comprising:
digitally applying a fixable fluid material to a portion of the substrate surface,
fixing the first fluid material to form a fixed coating in contact with the substrate surface, wherein the fixed coating has at least one boundary that encloses a region of the substrate surface within the at least one boundary, and wherein the fixed coating comprises at least one of a silicone and a fluoropolymer;
applying second fluid material comprising at least one of an adhesive and an adhesive precursor to at least a portion of the enclosed region of the substrate surface.

34. A method according to claim 33, wherein the second fluid material is adjacent to at least a portion of the fixed coating.

35. A method according to claim 33, wherein the fixed coating has the form of a continuous coating.

36. A method according to claim 33, wherein the fixed coating has the form of a discontinuous coating.

37. A method according to claim 33, wherein the fixed coating has at least two boundaries that taken together enclose a region of the substrate surface within the boundaries.

38. A method according to claim 33, wherein at least one of the first and second fluid materials has a viscosity of less than 30 millipascal-seconds at 60° C.

39. A method according to claim 33, wherein at least one of the first and second fluid materials is applied by inkjet printing.

40. A method according to claim 33, wherein at least one of the first and second fluid materials is applied by piezo inkjet printing.

41. A method according to claim 33, wherein fixing comprises evaporating.

42. A method according to claim 33, wherein fixing comprises cooling.

43. A method according to claim 33, wherein fixing comprises at least one of polymerizing and crosslinking.

44. A method according to claim 33, wherein the substrate comprises organic polymer.

45. A method according to claim 44, wherein the polymer is selected from the group consisting of polyimide, polyester, polyurethane, polyether, polyolefin, polyamide, and a combination thereof.

46. A method according to claim 33, wherein the substrate comprises a film, tape, or sheet.

47. A method according to claim 33, wherein the substrate comprises a fiber composite.

48. A method according to claim 33, wherein the substrate comprises at least one of a circuit board and a flex circuit.

49. A method according to claim 33, wherein the first fluid material comprises a fluoropolymer dispersion, a fluoropolymer solution, a silicone polymer, or a combination thereof.

50. A method according to claim 33, wherein the first fluid material comprises a fluoropolymer dispersion, a fluoropolymer solution, or a combination thereof.

51. A method according to claim 33, wherein the adhesive precursor comprises epoxy resin, cyanate resin, acrylate resin, or a combination thereof.

52. A method according to claim 33, further comprising at least partially curing the adhesive precursor to form at least partially cured adhesive precursor.

53. A method according to claim 33, wherein the at least partially cured adhesive precursor comprises a pressure sensitive adhesive.

54. A method according to claim 33, further comprising adhesively bonding a second substrate to the pressure sensitive adhesive.

55. A method according to claim 33, wherein the second fluid material comprises an adhesive precursor, further comprising contacting a second substrate with the second fluid material, and at least partially curing the adhesive precursor such that the second substrate becomes bonded to the first substrate.

56. A method according to claim 55, wherein the second substrate comprises at least one electrical component.

57. A method according to claim 33, wherein the second fluid material further comprises solvent, further comprising evaporating at least a portion of the solvent.

58. A method according to claim 57, wherein after evaporating at least a portion of the solvent, the second fluid material comprises a pressure sensitive adhesive.

59. A method according to claim 33, wherein the first fluid material is applied as an array of dots, and wherein the array has a resolution in at least one dimension of greater than or equal to 300 dots per inch.

60. A method according to claim 33, wherein the adhesive precursor contacts substantially the entire enclosed region of the substrate surface.

61. An article prepared according to the method of claim 1.

62. An article prepared according to the method of claim 33.

63. An article comprising:
a substrate having a surface;
a first coating supported on the surface of the substrate comprising at least one fluoropolymer, wherein the coating has at least one boundary enclosing a region of the substrate surface within the at least one boundary; and
a second coating, in contact with the enclosed region, comprising at least one of an adhesive and an adhesive precursor.

64. An article according to claim 63, wherein the substrate comprises a film, tape, or sheet.

65. An article according to claim 63, wherein the substrate comprises organic polymer.

66. An article according to claim 65, wherein the polymer is selected from the group consisting of polyimide, polyester, polyurethane, polyether, polyolefin, polyamide, and combinations thereof.

67. An article according to claim 63, wherein the substrate comprises at least one of a circuit board and a flex circuit.

68. An article according to claim 63, wherein the first fluid material comprises water-dispersible fluoropolymer, solvent-soluble fluoropolymer, or a combination thereof.

69. An article according to claim 63, wherein the adhesive precursor comprises epoxy resin, cyanate resin, acrylate resin, or a combination thereof.

70. An article according to claim 63, wherein the first region comprises an array of dots, and wherein the array has a resolution in at least one dimension of greater than or equal to 300 dots per inch.

71. An article according to claim 63, wherein the adhesive contacts substantially the entire enclosed region.
